(19) United States
(12) Patent Application Publication
(10) Pub. No.: US 2017/0110270 A1
(43) Pub. Date: Apr. 20, 2017

(54) ELECTRONIC COMPONENT

(71) Applicant: PANASONIC INTELLECTUAL PROPERTY MANAGEMENT CO., LTD., Osaka (JP)

(72) Inventors: Hisashi WATANABE, Okayama (JP); Yoshifumi AOI, Okayama (JP)

(21) Appl. No.: 15/126,504

(22) PCT Filed: Jan. 29, 2015
(86) PCT No.: PCT/JP2015/000385

§ 371 Date: Sep. 15, 2016

(30) Foreign Application Priority Data
Mar. 19, 2014 (JP) 2014-055931

(51) Int. Cl. H01H 13/81

(52) U.S. Cl. CPC H01H 13/81

(57) ABSTRACT

An electronic component of the present invention includes a resin case, and a terminal that is partially exposed from the resin case. Also, a first side surface along a protruding direction of the terminal includes a first plated surface and a first non-plated surface, and the first non-plated surface extends from a part of an upper end of the first side surface to a part of a lower end of the first side surface. Moreover, the first non-plated surface includes a first region that is exposed from the resin case, and a second region that is embedded in the resin case.

### TECHNICAL FIELD

The present invention relates to an electronic component to which a terminal protruding from a resin case is soldered.

### BACKGROUND ART

In recent years, many surface-mounted electronic components to be soldered to a wiring board are used in various electronic devices. Such an electronic component will be described with reference to FIGS. 11 to 16 by taking a conventional push switch to be soldered to a wiring board as an example. FIG. 11 is a perspective view of a conventional push switch, and FIG. 12 is an exploded perspective view of the conventional push switch. FIG. 13 is a cross-sectional view of the conventional push switch.

Resin case 1 is a case having a substantially rectangular shape, when seen from above, with a recessed portion which is open at the top, and is formed of insulating synthetic resin. As shown in FIG. 12, resin case 1 has first member 2 and second member 3, which are thin metal plates formed to have predetermined shapes and which are insert-molded while being electrically independent of each other. Additionally, details of a method for fabricating resin case 1 will be given later.

First member 2 includes contact portion 2A (center fixed contact) having a shape of a substantially circular truncated cone, when seen from above, and protruding slightly upward from a center of a bottom surface of the recessed portion of resin case 1, and terminals 2B protruding from side surfaces of resin case 1. Intermediate portions (not shown) connecting contact portion 2A and terminals 2B are embedded in resin case 1.

Second member 3 includes, on an outer circumferential side of the bottom surface of the recessed portion of resin case 1, two contact portions 3A (outer fixed contacts) having a substantially rectangular shape, when seen from above, and protruding slightly upward, and terminals 3B protruding from side surfaces of resin case 1. Intermediate portions (not shown) connecting contact portions 3A and terminals 3B are embedded in resin case 1. Additionally, two contact portions 3A (outer fixed contacts) described above are formed on the bottom surface of the recessed portion of resin case 1, at positions point-symmetrical to each other about contact portion 2A (center fixed contact).

Movable member 5 is circular when seen from above. Also, movable member 5 has a dome shape which protrudes upward, and is formed of an elastic thin metal plate. As shown in FIG. 13, a lower outer edge of movable member 5 is mounted on upper surfaces of contact portions 3A, and movable member 5 is accommodated inside the recessed portion of resin case 1. A lower surface at a center portion of movable member 5 faces contact portion 2A with a gap to an upper surface of contact portion 2A. Movable member 5 is a movable contact body having a point of contact with contact portion 2A (center fixed contact).

Protective sheet 6 is a flexible insulating film which is provided with adhesive 6A on a lower surface. Protective sheet 6 is fixedly stuck to an upper surface of resin case 1 by adhesive 6A on the lower surface so as to cover a top of the recessed portion of resin case 1.

The conventional push switch is configured as described above.

Next, operation of the conventional push switch will be described with reference to FIG. 13.

When a pressure is applied to the dome-shaped center portion of movable member 5 from above protective sheet 6, and the pressure exceeds a predetermined force, the dome-shaped center portion of movable member 5 is elastically reversed with a click so as to protrude downward. Then, the lower surface of the center portion of movable member 5 contacts the upper surface of contact portion 2A positioned below movable member 5. Contact portion 2A (center fixed contact) and contact portions 3A (outer fixed contacts) are thereby electrically connected through movable member 5, and a switched-on state is achieved in which corresponding terminals 2B, 3B are electrically connected.

Then, when the pressure is released, the dome-shaped center portion of movable member 5 is elastically restored with a click so as to protrude upward, and the lower surface of the center portion of movable member 5 is separated from the upper surface of contact portion 2A. Then, a switched-off state is achieved in which corresponding terminals 2B, 3B are insulated from each other.

As such a conventional push switch, Patent Literature 1 is known, for example.

Next, a method for fabricating resin case 1 of the conventional push switch will be described with reference to FIGS. 14 to 16.

FIG. 14 is a top view of metal hoop 11 of the conventional push switch. Metal hoop 11 is obtained by punching into a predetermined shape, by stamping or the like, a long strip-shaped metal material whose upper and lower surfaces are plated in advance to enhance solder wettability, and then subjecting the metal material to bending or drawing to achieve a predetermined shape.

After insert-molding, first member portion 12 to be first member 2 (shown in FIG. 12), and second member portion 13 to be second member 3 (shown in FIG. 12) are formed to metal hoop 11.

After insert-molding, contact portion 12A to be contact portion 2A (shown in FIG. 12), and terminal portions 12B to be terminals 2B (shown in FIG. 12) are formed to first member portion 12. Also, terminal portions 12B are coupled to frame portion 14 of metal hoop 11. First member portion 12 is integrated with metal hoop 11.

After insert-molding, contact portion 13A to be contact portion 3A (shown in FIG. 12), and terminal portions 13B to be terminals 3B (shown in FIG. 12) are formed to second member portion 13. Also, terminal portions 13B are coupled to frame portion 14 of metal hoop 11. Second member portion 13 is integrated with metal hoop 11.

Metal hoop 11 described above is insert-molded to resin case 1 (shown in FIG. 12) by injection molding. A method for insert-molding metal hoop 11 will be described below with reference to FIGS. 15, 16.

FIGS. 15, 16 are diagrams for describing a state in which the metal hoop is accommodated inside a cavity. FIG. 15 is a side view seen from distal end sides of terminal portions 12B and 13B. FIG. 16 is a top view from which upper mold 22 is omitted.

First member portion 12 and second member portion 13 of metal hoop 11 (shown in FIG. 14) are accommodated inside cavity 20A of mold 20 constituted by fitting lower mold 21 and upper mold 22 together. At this time, terminal portions 12B, 13B of metal hoop 11 protrude outside cavity 20A from opening portions 20B of mold 20.

Additionally, in FIGS. 15, 16, to clarify the key points of the conventional technique, only first member portion 12 and second member portion 13 of metal hoop 11 are shown, and frame portion 14 positioned outside terminal portions 12B, 13B is omitted from the drawings.

First member portion 12 and second member portion 13 are insert-molded by filling the inside of cavity 20A with thermoplastic insulating resin which is melted at a high temperature, that is, by performing so-called injection molding, and resin case 1 is thereby fabricated.

Gaps 20C between opening portions 20B of mold 20 and side surfaces of terminal portions 12B, 13B are designed to be as small as possible so that the resin which is melted at the time of injection molding described above does not leak outside cavity 20A. Additionally, in FIGS. 15, 16, gaps 20C are shown in an enlarged manner.

Moreover, after the insert-molding described above, terminal portions 12B, 13B are cut off from frame portion 14 (shown in FIG. 14) of metal hoop 11, and resin case 1 (shown in FIGS. 11, 12) is thereby formed.

When resin case 1 is formed by the method described above, the upper and the lower surfaces of each of terminals 2B, 3B protruding from resin case 1 are plated.

Side surfaces at distal ends of terminals 2B. 3B are cut surfaces that are cut off from frame portion 14. Side surfaces along protruding directions of terminals 2B, 3B are cut surfaces formed at the time of stamping. Accordingly, the entire areas of the side surfaces are non-plated surfaces. Therefore, solder wettability on the side surfaces of terminals 2B, 3B is lower than on the upper and lower surfaces of terminals 2B, 3B.

Accordingly, a push switch with terminals 2B, 3B whose side surfaces are plated is being proposed with the aim of increasing soldering strength of a push switch, for example.

A method for fabricating the push switch is as follows. First, a long strip-shaped metal material which is not plated is punched. Then, plating layers are formed by plating first member portion 12 and second member portion 13, and then, by performing insert-molding, plating layers are formed also on the side surfaces of terminals 2B, 3B.

Additionally, as information of prior art documents related to the invention of the present application, Patent Literature 2 is known, for example.

### CITATION LIST

### Patent Literature

PTL 1: Unexamined Japanese Patent Publication No. 2011-60627

PTL 2: Unexamined Japanese Patent Publication No. 2007-234423

### SUMMARY OF THE INVENTION

An electronic component of the present invention includes a resin case, and a terminal that is partially exposed from the resin case. In addition, a first side surface of the terminal along a protruding direction of the terminal includes a first plated surface and a first non-plated surface, and the first non-plated surface extends from a part of an upper end of the first side surface to a part of a lower end of the first side surface. Moreover, the first non-plated surface includes a first region that is exposed from the resin case, and a second region that is embedded in the resin case.

According to such a configuration, a plating layer may be prevented from being peeled off at the time of insert-molding.

### BRIEF DESCRIPTION OF DRAWINGS

FIG. 1 is a perspective view of a push switch according to a first exemplary embodiment.

FIG. 2 is an enlarged view showing main portions in FIG. 1.

FIG. 3 is an exploded perspective view of the push switch according to the first exemplary embodiment.

FIG. 4 is a cross-sectional view of the push switch according to the first exemplary embodiment.

FIG. 5 is a top view of a metal hoop after first stamping.

FIG. 6A is an enlarged view showing main portions of the metal hoop after second stamping.

FIG. 6B is an enlarged view showing main portions of the metal hoop after second stamping.

FIG. 6C is an enlarged view showing main portions of the metal hoop after second stamping.

FIG. 7 is a diagram describing a state in which the metal hoop is accommodated inside a cavity.

FIG. 8 is a diagram describing a state in which the metal hoop is accommodated inside the cavity.

FIG. 9 is a top view showing a terminal of a push switch according to a second exemplary embodiment and its periphery.

FIG. 10 is a top view showing a terminal of a push switch according to a third exemplary embodiment and its periphery.

FIG. 11 is a perspective view of a conventional push switch.

FIG. 12 is an exploded perspective view of the conventional push switch.

FIG. 13 is a cross-sectional view of the conventional push switch.

FIG. 14 is a top view of a metal hoop.

FIG. 15 is a diagram for describing a state in which the metal hoop is accommodated inside a cavity.

FIG. 16 is a diagram for describing a state in which the metal hoop is accommodated inside the cavity.

### DESCRIPTION OF EMBODIMENTS

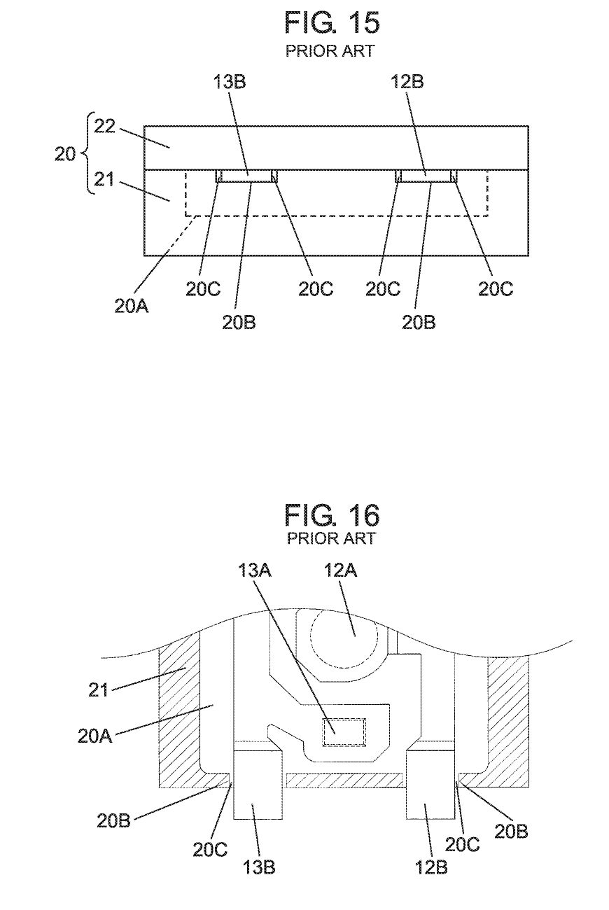

Before describing exemplary embodiments, a problem, noticed by the inventors, which occurs at the time of insert-molding of a push switch with terminals whose side surfaces are plated will be described with reference to FIGS. 15, 16.

When resin case 1 is formed by insert-molding first member portion 12 having plating layers formed on side surfaces of contact portions 12A and terminal portion 12B and second member portion 13, it is conceivable that a phenomenon occurs according to which opening portions 20B of mold 20 and side surfaces of terminal portions 12B, 13B are rubbed against each other and the plating layers are peeled off, at the time of insert-molding.

The phenomenon will be described. Gaps 20C between opening portions 20B of mold 20 and terminal portions 12B, 13B are designed to be as small as possible. Accordingly, at the time of disposing first member portion 12 and second member portion 13 inside cavity 20A, side surfaces of terminal portions 12B, 13B may be rubbed against opening portions 20B. Accordingly, in a case where plating layers are formed on the side surfaces of terminal portions 12B, 13B, the plating layers at the rubbed parts are peeled off.

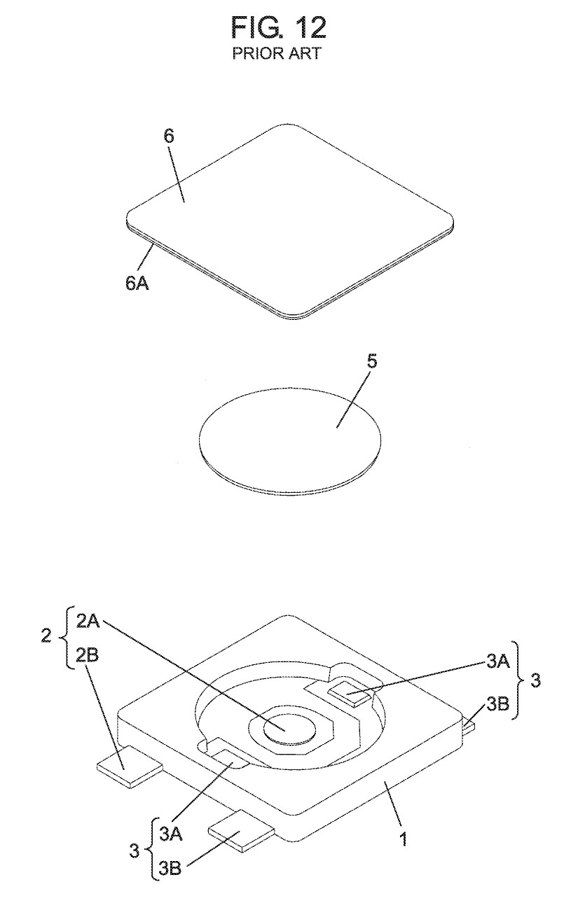

Accordingly, with the push switch shown in FIGS. 15, 16 which is produced by using first member portion 12 and second member portion 13 having plating layers formed on side surfaces of terminal portions 12B, 13B, there is a possibility that an inconvenience is caused, such as plating flakes entering resin case 1 and causing short-circuit between terminal 2B and terminal 3B (shown FIG. 12). Accordingly, with insert-molding of the push switch shown in FIGS. 15, 16, sufficient management is required to prevent short-circuit.

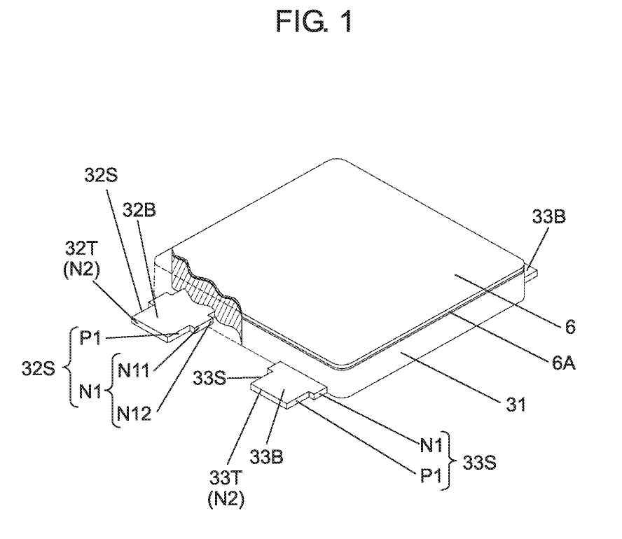

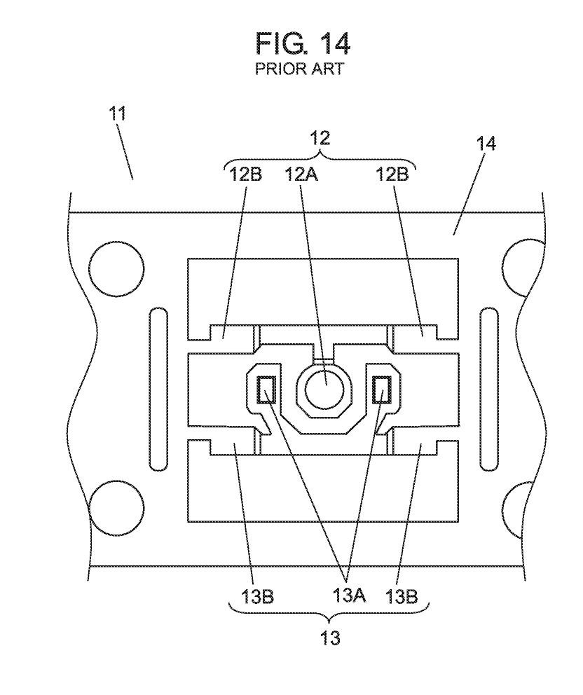

In the following, exemplary embodiments of an electronic component of the present invention will be described with reference to FIGS. 1 to 10. Additionally, a push switch is an example of the electronic component, and in the exemplary embodiments of the present invention described below, description will be given using the push switch. In addition, structural elements having the same configuration as those shown in FIGS. 12 to 16 will be denoted with the same reference signs, and description may be simplified or omitted.

### First Exemplary Embodiment

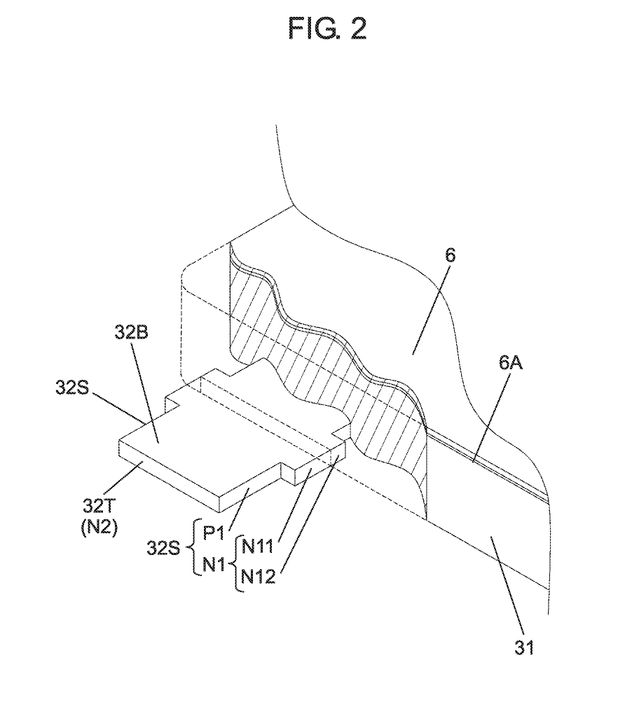

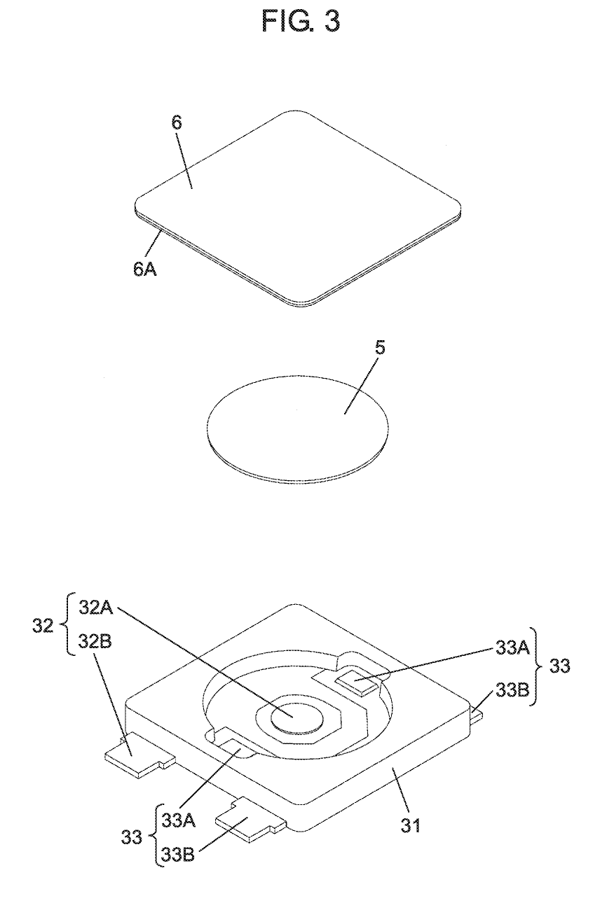

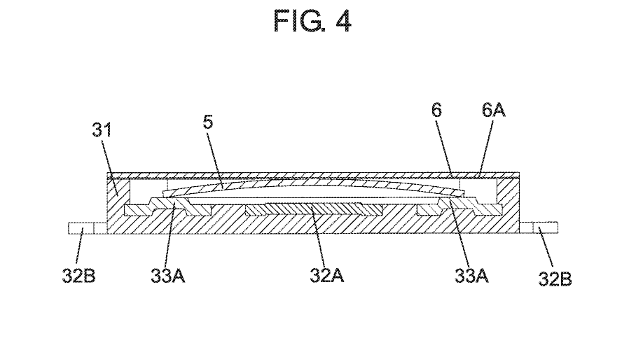

FIG. 1 is a perspective view of a push switch according to a first exemplary embodiment of the present invention, FIG. 2 is an enlarged view showing main portions in FIG. 1, and FIG. 3 is an exploded perspective view of the push switch according to the first exemplary embodiment. FIG. 4 is a cross-sectional view of the push switch according to the first exemplary embodiment. Additionally, in FIGS. 1, 2, the push switch is shown in a partially cut-out manner for the sake of convenience in description.

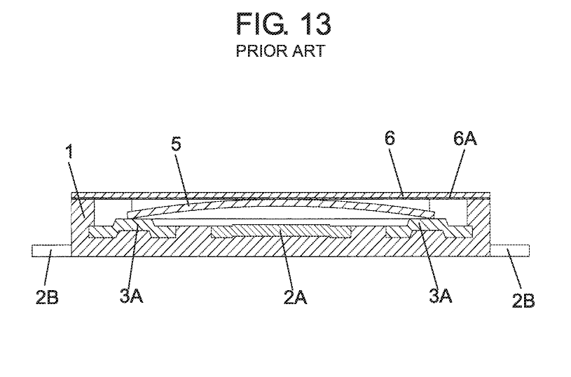

As shown in FIG. 4, the push switch of the present exemplary embodiment includes resin case 31, movable member 5, and protective sheet 6. Additionally, movable member 5 and protective sheet 6 are the same as those of the conventional push switch described with reference to FIG. 13, and detailed description will be omitted. Resin case 31 includes a recessed portion which is open upward, and is formed of insulating resin. Like conventional resin case 1 (shown in FIG. 13), first contact portion 32A (center fixed contact), which has a substantially circular truncated cone shape and which protrudes slightly, is provided at a center portion of a bottom surface of the recessed portion. Moreover, two second contact portions 33A (outer fixed contacts), which are substantially rectangular and which protrude slightly, are provided at an outer peripheral portion of the bottom surface of the recessed portion of resin case 31.

Furthermore, terminals 32B coupled to first contact portion 32A and terminals 33B coupled to second contact portions 33A (outer fixed contacts) each protrude outward from a side surface portion of resin case 31.

Like conventional resin case 1, resin case 31 has first member 32 and second member 33, which are thin metal plates formed to have predetermined shapes and which are insert-molded while being electrically independent of each other, and intermediate portions (not shown) of first member 32 and second member 33 are each embedded in resin case 31. Additionally, insert-molding will be described later.

According to the push switch of the present exemplary embodiment, plating layers are formed at predetermined regions on side surfaces of first member 32 and second member 33. That is, plating layers are formed at predetermined regions of side surfaces of terminals 32B, 33B. Details of the regions, on the side surfaces of terminals 32B, 33B, where the plating layers are formed, and the like will be given later. Additionally like the conventional push switch, the plating layers are formed on upper and lower surfaces of first member 32 and second member 33.

Movable member 5 is accommodated inside the recessed portion of resin case 31, and a lower outer edge of movable member 5 is mounted on upper surfaces of contact portions 33A. In addition, a lower surface at a center portion of movable member 5 faces first contact portion 32A with a gap to an upper surface of first contact portion 32A.

Moreover, protective sheet 6 is bonded to an upper surface of resin case 31 by adhesive 6A on a lower surface so as to cover the recessed portion of resin case 31.

The push switch according to the first exemplary embodiment of the present invention is configured in the above manner. Additionally, operation of the switch is the same as conventional operation, and description is omitted.

Next, details of the regions, on the side surfaces of terminals 32B, 33B of the push switch, where the plating layers are formed, and the like will be given.

As shown in FIG. 1, for example, terminals 32B, 33B protrude outward from resin case 31. Additionally terminals 32B, 33B are partially embedded in resin case 31.

Terminals 32B, 33B are narrow at distal end portions, and slightly wider at base portions on the sides of resin case 31. Moreover, parts of terminals 32B, 33B embedded in resin case 31 are also slightly wide.

Terminals 32B, 33B are formed as thin metal plates of phosphor bronze, brass, SUS, or the like. Plating layers of alloy or metal, such as silver, with high solder wettability are formed on upper and lower surfaces of terminals 32B, 33B. Additionally, the plating layers are formed on plating base layers of nickel or the like which are formed on base material of thin metal plates. Moreover, the method for forming the plating layers is not limited to the method described above.

As shown in FIGS. 1, 2, for example, terminal 32B of the present exemplary embodiment includes at least three side surfaces. The at least three side surfaces are side surface 32T at a distal end portion of terminal 32B, and two side surfaces 32S along the protruding direction of terminal 32B.

Similarly, side surfaces of terminal 33B include at least three side surfaces. The at least three side surfaces are side surface 33T at a distal end portion of terminal 33B, and two side surfaces 33S along the protruding direction of terminal 33B.

First plated surface P1 on which a plating layer is formed, and first non-plated surface N1 on which a plating layer is not formed are formed to each of side surfaces 32S. 33S.

First non-plated surface N1 formed to each of side surfaces 32S, 33S includes first region N11, which is exposed to outside resin case 31, and second region N12, which is embedded inside resin case 31.

Additionally, in FIGS. 1, 2, resin case 31 is shown in a partially cut-out manner for the sake of convenience in description, and thus second region N12 of terminal 32B embedded inside resin case 31 is shown. On the other hand, second region N12 of terminal 33B is embedded inside resin case 31, and is not shown.

Additionally, side surface 32T and side surface 33T are second non-plated surfaces N2 on which plating layers are not formed.

As described above, according to the push switch of the present exemplary embodiment, side surfaces 32S, 33S of terminals 32B, 33B protruding outward from resin case 31 include first plated surfaces P1 where plating layers are formed. Accordingly, the mounting strength at the time of solder-mounting the push switch of the present exemplary embodiment may be increased.

<Method for Forming Metal Hoop>

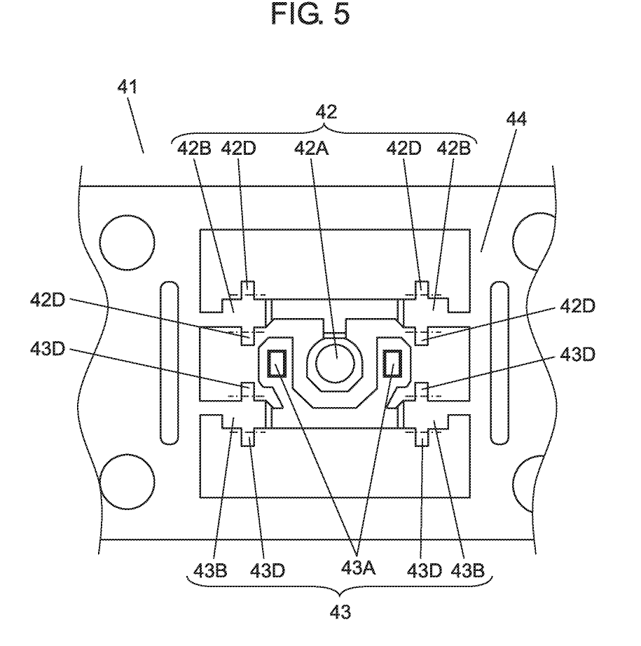

Next, a method for producing the push switch of the first exemplary embodiment will be described with reference to FIGS. 5 to 8. Additionally, resin case 31 (shown in FIG. 3) is formed by insert-molding metal hoop 41, as in the case of conventional resin case 1. However, the step for forming metal hoop 41 of the present exemplary embodiment is different from the conventional forming method.

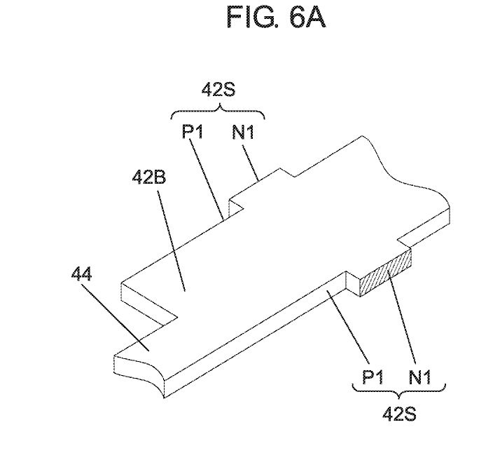

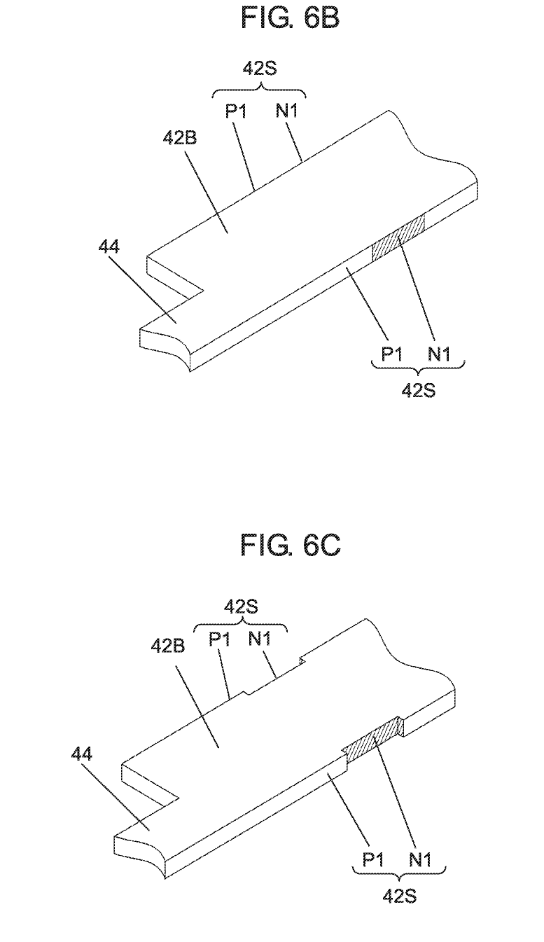

FIG. 5 is a top view of metal hoop 41 after first stamping, and FIGS. 6A to 6C are enlarged views showing main portions of metal hoop 41 after second stamping.

First, a long strip-shaped metal material which is not plated is stamped (first stamping), and a work in progress to which first member portion 42 to be first members 32 (shown in FIG. 3) and second member portion 43 to be second members 33 (shown in FIG. 3) are formed is formed, as shown in FIG. 5.

Additionally, in the first stamping, first contact portion 42A (center fixed contact portion), terminal portions 42B, and dummy portions 42D extending from both sides of terminal portions 42B with a predetermined width are formed to first member portion 42.

Similarly, second contact portions 43A (outer fixed contact portions), terminal portions 43B, and dummy portions 43D extending from both sides of terminal portions 43B with a predetermined width are formed to second member portion 43.

Terminal portions 42B, 43B are coupled to frame portion 44 of metal hoop 41, and first member portion 42 and second member portion 43 are integrated with metal hoop 41.

Next, by plating the work in progress, plating layers are formed on entire upper, lower and side surfaces of the work in progress.

Next, dummy portions 42D, 43D are cut along dashed-dotted lines in FIG. 5 by stamping (second stamping). Dummy portions 42D, 43D are separated by the second stamping, and metal hoop 41 is completed.

As described above, dummy portions 42D, 43D are cut after plating, and thus, the cut surfaces are first non-plated surfaces N1 on which plating layers are not formed. A hatched portion shown in FIG. 6A is first non-plated surface N1 formed to terminal portion 42B. Additionally, only one side surface 42S is shown in a hatched manner in FIG. 6A, but first non-plated surface N1 is formed also on the other side surface 42S.

First non-plated surface N1 reaches each of the upper and lower surfaces of terminal portion 42B. First non-plated surfaces N1 are at both end portions of terminal portion 42B in the width direction. First non-plated surface N1 extends from an upper end of side surface 42S to a lower end of side surface 42S.

With the push switch according to the first exemplary embodiment shown in FIGS. 1 and 2, first non-plated surface N1 reaches each of the upper and lower surfaces of terminal 32B. Also, first non-plated surface N1 extends from a part of an upper end of side surface 32S (first side surface) to a part of a lower end of side surface 32S (first side surface).

Additionally, same first non-plated surface N1 is also formed to terminal portion 43B. That is, with the push switch according to the first exemplary embodiment shown in FIG. 1, first non-plated surface N1 reaches each of the upper and lower surfaces of terminal 33B, in the same manner as for terminal 32B.

As is clear from the description above, the cut surfaces of dummy portions 42D, 43D of metal hoop 41 are first non-plated surfaces N1, and plating layers are formed on all the side surfaces of metal hoop 41 other than the cut surfaces.

That is, side surface 42S of terminal portion 42B includes first plated surface P1 on which a plating layer is formed, and first non-plated surface N1 which is the cut surface of dummy portion 42D and on which a plating layer is not formed. Like side surface 42S of terminal portion 42B, a side surface (not shown) of terminal portion 43B also includes a first plated surface on which a plating layer is formed, and a first non-plated surface which is the cut surface of dummy portion 43D and on which a plating layer is not formed.

Additionally, with the push switch shown in FIGS. 1 and 2, side surface 32S of terminal 32B includes first plated surface P1 on which a plating layer is formed, and first non-plated surface N1 on which a plating layer is not formed.

Furthermore, as in the case of terminal 32B, side surface 33S of terminal 33B also includes first plated surface P1 on which a plating layer is formed, and first non-plated surface N1 on which a plating layer is not formed.

Additionally, dummy portions 42D, 43D described with reference to FIGS. 5, 6A are cut, in the second stamping, at positions slightly protruding from first plated surfaces P1 of terminal portions 42B, 43B. That is, to cut the cutting surface (first non-plated surface N1) at a position slightly protruding from first plated surface P1 is desirable from the standpoint of facilitating processing.

However, the structure of side surface 42S is not limited to the structure shown in FIG. 6A. For example, as shown in FIG. 6B, dummy portion 42D, 43D may be cut in such a way that the cut surface (first non-plated surface N1) and first plated surface P1 are flat.

Furthermore, as shown in FIG. 6C, dummy portion 42D, 43D may be cut in such a way that the cut surface (first non-plated surface N1) is recessed with respect to first plated surface P1.

<Insert-Molding>

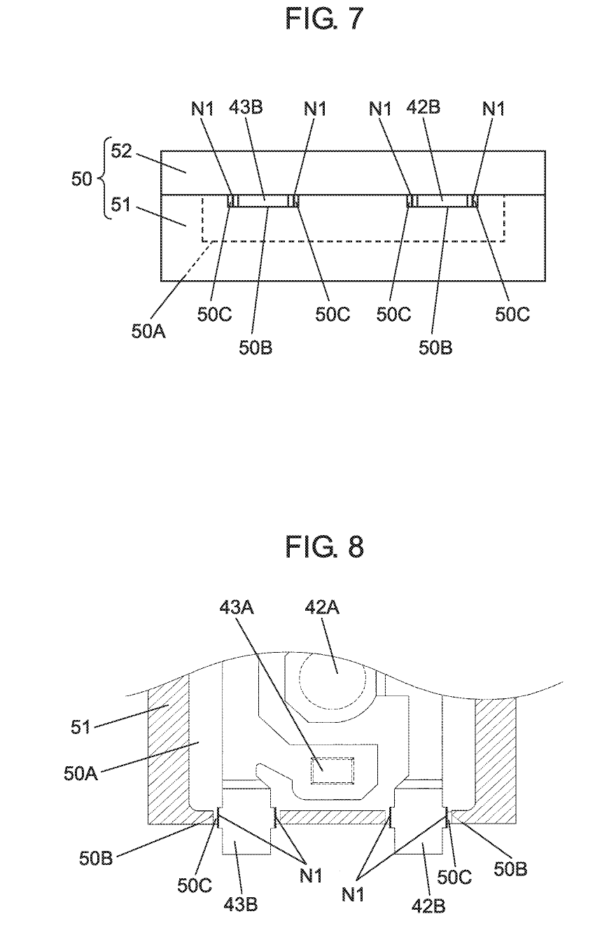

Next, insert-molding will be described. FIGS. 7, 8 are diagrams describing a state in which metal hoop 41, described with reference to FIG. 5, FIGS. 6A to 6C, is accommodated inside a cavity. FIG. 7 is a side view seen from distal end sides of terminal portions 42B and 43B. FIG. 8 is a top view from which upper mold 52 is omitted. As in the conventional case, metal hoop 41 is accommodated inside cavity 50A of mold 50. Then, by filling the inside of cavity 50A with thermoplastic insulating resin which is melted at a high temperature, that is, by performing so-called injection molding, first member portion 42 and second member portion 43 are insert-molded. Resin case 31 (shown in FIG. 3) is thereby formed.

As shown in FIG. 7, mold 50 is constituted from lower mold 51 and upper mold 52, and terminal portions 42B, 43B of metal hoop 41 protrude from opening portions 50B of mold 50 to outside cavity 50A.

Additionally, in FIGS. 7, 8, only first member portion 42 and second member portion 43 of metal hoop 41 are shown, and the structure of metal hoop 41 outside terminal portions 42B, 43B is omitted from the drawings. That is, frame portion 44 is omitted. Also, first non-plated surfaces N1 are shown with thick lines such that the regions of first non-plated surfaces N1 provided to terminal portions 42B, 43B can be easily distinguished.

As in the conventional case, gaps 50C between opening portions 50B of mold 50 and first non-plated surfaces N1 of terminal portions 42B, 43B are designed to be as small as possible so that resin that is melted at the time of injection molding does not leak outside cavity 50A.

Accordingly, at the time of placing first member portion 42 and second member portion 43 inside cavity 50A, side surfaces of terminal portions 42B, 43B may be rubbed against opening portions 50B of mold 50. In the case of using metal hoop 41 of the present exemplary embodiment described above, regions of the side surfaces of terminal portions 42B, 43B which are rubbed against opening portions 50B are, as shown in FIG. 8, first non-plated surfaces N1 on which plating layers are not formed. Accordingly, even if terminal portions 42B, 43B are rubbed against opening portions 50B of mold 50, generation of plating flakes is suppressed.

Additionally, as shown in FIG. 8, insert-molding is performed with parts of first non-plated surfaces N1 of terminal portions 42B, 43B of metal hoop 41 positioned slightly inside cavity 50A. Accordingly, as shown in FIGS. 1 and 2, first non-plated surface N1 of the push switch is formed from second region N12, which is embedded inside resin case 31, and first region N11, which protrudes outward from resin case 31.

Next, as shown in FIG. 4, movable member 5 is mounted inside the recessed portion of resin case 31 by placing the lower outer edge of movable member 5 on upper surfaces of second contact portions 33A. Then, protective sheet 6 is bonded to the upper surface of resin case 31 by adhesive 6A provided on the lower surface of protective sheet 6 so as to cover the recessed portion of resin case 31.

The push switch of the first exemplary embodiment is then completed by separating each of terminal portions 42B, 43B from frame portion 44 by third stamping. Additionally, a distal end (side surface 32T) of terminal 32B shown in FIG. 1 is a cut surface, and is thus second non-plated surface N2 on which a plating layer is not formed.

According to the present exemplary embodiment, a plating layer may be prevented from being peeled off at the time of insert-molding. Therefore, inconveniences related to an electronic component such as a push switch provided with insert-molded resin case 1 may be reduced.

### Second Exemplary Embodiment

Next, a push switch according to a second exemplary embodiment will be described. Same structural elements as those in the first exemplary embodiment will be denoted with the same reference signs. Also, matters that are common with the first exemplary embodiment will be omitted from the description.

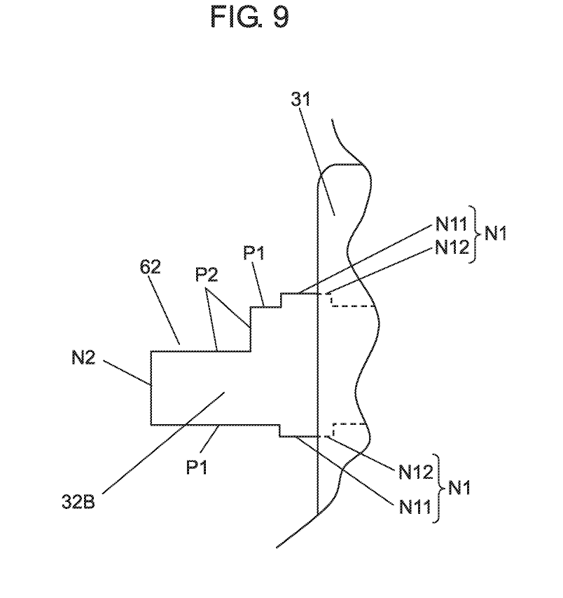

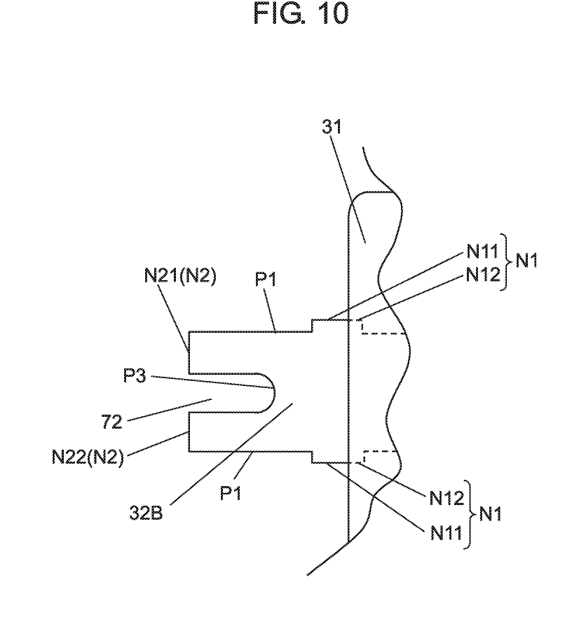

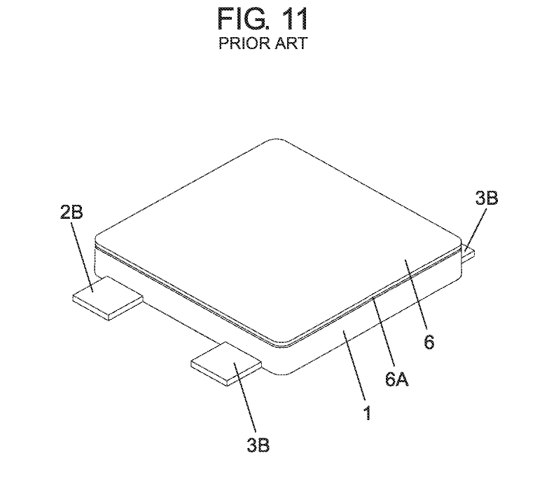

FIG. 9 is a top view showing a terminal of a push switch according to the second exemplary embodiment of the present invention and its periphery. Cut-out portion 62 is newly provided to a distal end portion of terminal 32B. Additionally, cut-out portion 62 is also provided to terminal 33B, but is omitted from the drawing and the detailed description.

Cut-out portion 62 is cut out such that terminal 32B is L-shaped when seen from above, and side surfaces of cut-out portion 62 form second plated surfaces P2 on which plating layers are formed. Additionally, second plated surfaces P2 may be easily formed by providing the cut-out portion to a base material in advance by the first stamping described above, for example, and by forming plating layers on the cut-out portion.

According to the push switch of the second exemplary embodiment described above, the area of the plated surfaces formed on side surfaces of terminal 32B is greater than that in the first exemplary embodiment. Accordingly, in addition to being able to achieve the same effect as the first exemplary embodiment, the push switch of the second exemplary embodiment may further increase the mounting strength of the push switch on the wiring board.

### Third Exemplary Embodiment

Next, a push switch according to a third exemplary embodiment will be described. Same structural elements as those in the first exemplary embodiment will be denoted with the same reference signs. Also, matters that are common with the first exemplary embodiment will be omitted from the description.

FIG. 10 is a top view showing a terminal of a push switch according to the third exemplary embodiment of the present invention and its periphery, and cut-out portion 72 is newly provided to a distal end portion of terminal 32B. Because cut-out portion 72 is formed, a side surface at a distal end of terminal 32B is divided into two regions (third region N21 and fourth region N22). Additionally, cut-out portion 72 is also provided to terminal 33B, but is omitted from the drawing and the detailed description.

Cut-out portion 72 is cut out in a U-shape when seen from above, and a side surface of cut-out portion 72 forms third plated surface P3 on which a plating layer is formed. Additionally, terminal distal ends on both sides of cut-out portion 72 are cut surfaces, and thus, third region N21 and fourth region N22 are second non-plated surfaces N2 on which plating layers are not formed. Moreover, third plated surface P3 may be easily formed by providing a through hole to a base material in advance by the first stamping described above, for example, and by forming a plating layer on the through hole.

According to the push switch of the third exemplary embodiment described above, the area of the plated surfaces formed on side surfaces of terminal 32B is greater than that in the first exemplary embodiment. Accordingly, in addition to being able to achieve the same effect as the first exemplary embodiment, the push switch of the third exemplary embodiment may further increase the mounting strength of the push switch on the wiring board.

Additionally, the push switches described in the first to the third exemplary embodiments are examples of an electronic component, and the idea of the present invention is not limited to the push switches. For example, electronic components including a resin case and a terminal which is partially exposed from the resin case, such as an encoder, a variable resistor, and various switches other than the push switches configured in the above manner, also belong to the technical field of the present invention.

### INDUSTRIAL APPLICABILITY

An electronic component of the present invention is an electronic component having a plating layer formed on a side surface of a terminal, according to which the plating layer formed on the side surface of a terminal portion is prevented from being peeled off at the time of insert-molding. This is advantageous for an electronic device on which the electronic component of the present invention is to be soldered.

### REFERENCE MARKS IN THE DRAWINGS

5 movable member
6 protective sheet
6A adhesive
31 resin case
32 first member
32A first contact portion (center fixed contact)
32B, 33B terminal
32T, 33T side surface
32S, 33S, 42S side surface
33 second member
33A second contact portion (outer fixed contact)
41 metal hoop
42 first member portion
42A first contact portion (center fixed contact portion)
42B, 43B terminal portion
42D, 43D dummy portion
43 second member portion
43A second contact portion (outer fixed contact portion)
44 frame portion
50 mold
50A cavity
50B opening portion
50C gap
51 lower mold
52 upper mold
62, 72 cut-out portion
N1 first non-plated surface
N11 first region
N12 second region
N2 second non-plated surface
N21 third region
N22 fourth region
P1 first plated surface
P2 second plated surface
P3 third plated surface

1. An electronic component comprising:
a resin case; and
a terminal that is partially exposed from the resin case,
wherein
a first side surface of the terminal along a protruding direction of the terminal includes a first plated surface and a first non-plated surface,
the first non-plated surface extends from a part of an upper end of the first side surface to a part of a lower end of the first side surface, and
the first non-plated surface includes a first region that is exposed from the resin case, and a second region that is embedded in the resin case.

2. The electronic component according to claim 1, wherein the first non-plated surface is positioned on an outer side with respect to the first plated surface in a width direction of the terminal.

3. The electronic component according to claim 1, wherein the first non-plated surface is positioned on an inner side with respect to the first plated surface in a width direction of the terminal.

4. The electronic component according to claim 1, wherein
the terminal includes a cut-out portion at an end portion, and
the cut-out portion includes a second plated surface.

5. The electronic component according to claim 1,
wherein the terminal includes, at an end portion,
a cut-out portion that is recessed toward the resin case, and
a second non-plated surface that is not plated,
the second non-plated surface includes a third region and a fourth region, and
the cut-out portion is positioned between the third region and the fourth region, and includes a third plated surface.
